(19) United States
(12) Patent Application Publication
(10) Pub. No.: US 2012/0073296 A1
(43) Pub. Date: Mar. 29, 2012

(54) ROTARY CAM RADIAL STEAM ENGINE

(76) Inventor: Michael W. Courson, Alpine, CA (US)

(21) Appl. No.: 12/888,985

(22) Filed: Sep. 23, 2010

(51) Int. Cl. F01K 23/06; B23P 17/00; F01B 1/06

(52) U.S. Cl. 60/670; 92/148; 29/888

(57) ABSTRACT

The present invention is directed to a Rotary Cam Radial Steam Engine of a single or multiple pistons and cylinders, which are driven lineally by the introduction of pressure from an external source, through a single, centralized rotating valve. The valve has been designed to provide timed introduction of the pressurized gasses into each cylinder at the moment determined to be best for the engine's applied use, and then the same central rotating valve assembly at the appropriate moment opens to allow the used pressure to exhaust it into the atmosphere, or a collection system. The lineal direction of the pistons is then directed outward and onto an external rotating cam which converts the lineal energy into circular rotating energy. The engine can be disassembled for servicing or complete rebuilding and reassembled quickly with use of no tools. With the need for efficient energy generation, there is a growing requirement for a lighter weight, long lasting, economical motors with affordable ease of maintenance to be used on different applications capable using a variety of different power generating sources.

### FIELD OF THE INVENTION

The present invention provides a lightweight multiple piston rotary cam radial engine capable of being powered by a variety of different means including steam, compressed air, pressurized gases or fluids.

### BACKGROUND OF THE INVENTION

A steam engine is mechanical device used to transfer the energy of steam into mechanical energy for a variety of applications, including propulsion and generating electricity. The basic principle of the steam engine involves transforming the heat energy of steam into mechanical energy by permitting the steam to expand and cool in a cylinder equipped with a movable piston. Steam that is to be used for power or heating purposes is usually generated in a boiler. The simplest form of boiler is a closed vessel containing water, which is heated by a flame so that the water turns to saturated steam.

Steam engines, heat engines using boiling water to produce mechanical motion, have a long history, going back at least 2000 years. Early devices were not practical power producers, but more advanced designs producing usable power have become a major source of mechanical power over the last 300 years, enabling the industrial revolution, beginning with applications for mine water removal using vacuum engines.

Subsequent developments using pressurized steam and conversion to rotary motion enabled the powering of a wide range of manufacturing machinery anywhere water and coal or wood fuel could be obtained, previously restricted only to locations where water wheels or windmills could be used. Significantly, this power source would later be applied to prime movers, mobile devices such as steam tractors and railway locomotives. Modern steam turbines generate about 80 percent of the electric power in the world using a variety of heat sources.

Steam engines were the first engine type to see widespread use. They were first invented by Thomas Newcomen in 1705, and James Watt who made big improvements to steam engines in 1769. The steam engine developed by James Watt is generally credited as being the first efficient steam engine. A steam engine is a heat engine that performs mechanical work using steam as its working fluid. Steam engines are typically external combustion engines, although other external sources of heat such as solar power, nuclear power or geothermal energy may be used. The heat cycle is known as the Rankine cycle.

There have been many newer and more recent innovations to the steam engines and they have generally continued using high-pressure steam as a driving force requiring extremely heavily constructed equipment. These types of steam engine normally work with a piston that drives a central output shaft.

Pneumatic motors operate on a similar application of compressed air instead of steam. These motors are generally smaller and lighter weight and operate at high revolutions.

With the need for efficient energy generation, there is a growing requirement for a lighter weight, economical motors to be used on different applications capable of using a variety of different power generating sources including, but not limited to steam. These power sources could also include compressed air, compressed gases and pressurized fluids.

Numerous innovations for steam engines and air-operated motors have been provided in the prior art that are described as follows. Even though these innovations may he suitable for the specific individual purposes to which they address, they differ from the present design as hereinafter contrasted. The following is a summary of those prior art patents most relevant to this application at hand, as well a description outlining the difference between the features of the Rotary Cam Radial Steam Engine and the prior art.

U.S. Pat. No. 3,967,535 of Murry I. Rozanski describes a uniflow steam engine of the multi-cylinder type wherein the cylinders are rotatably mounted within a jacket having a sinusoidal cam track therein. Extending through slots, the ends of which are the exhaust ports in the cylinders and into the cam track are cam followers, which are mounted on the pistons for reciprocal movement therewith. At the head end of the cylinders, there are apertures which rotate with registered cutouts in superimposed valve rings that control the flow of steam from manifolds at the head ends of each of the cylinders into the cylinders as the cylinders rotate. By adjusting the relative position between the valve rings, the length of time of steam introduced on each cycle may be adjusted and by concomitantly rotating both valve rings, the initial time for introduction of steam may be adjusted to alter lead or reverse torque.

This patent describes a multi-cylinder unconventional uniflow type of steam engine in a compact design. By using a multi-cylinder type, wherein the cylinders are rotatably mounted within a jacket having a sinusoidal cam track it differs in that the Rotary Cam Radial Steam Engine uses one or more pistons with a revolving rotating outer cam ring. It also differs from the multi-cylinder unconventional uniflow type in that the Rotary Cam Radial Steam Engine can be very light weight and can be made primarily of plastic.

U.S. Pat. No. 4,132,213 of R. Homer Weaver describes a rotary engine having a power output shaft, a drive unit for rotating the shaft, the drive unit including a rotary drive element affixed to the shaft, and a stationary element for supporting the shaft rotatably. A pair of diametrically spaced, rotatable, paddle-like pistons are mounted on the rotary drive element. The paddle-like pistons rotate into and out of opposing, complementary cavities formed in the rotary drive element and in the stationary element. The complemented cavities function as revolving cylinders or chambers for the reception of a high pressure, expansible fluid. The expansible fluid drives the pistons to impart rotation to the rotary element, to drive the power output shaft. A source of high pressure expansible fluid is provided, together with a valve system connecting the fluid source to the drive unit. The valve system is automatically operative to discharge the fluid under high pressure into the drive unit chambers at periodic intervals. The source of high-pressure fluid may comprise a compressor having a construction similar to that of the drive unit, for receiving and compressing a fuel and air mixture. The engine is adaptable to be utilized as a gasoline internal combustion engine, a diesel engine, a steam engine, or any other type of engine using high pressure, expansible fluids.

This patent describes a rotary engine having a power output shaft. It differs in that it uses rotatable paddle like pistons mounted on a rotary drive element using high pressure instead of a conventional piston. This device would require it to be made of a heavy material that would be capable of taking the high pressure and could not be made of plastic or materials not capable of sustaining high stress levels.

U.S. Pat. No. 5,364,249 of Donald M. Link tells of a rotary steam engine that has a working chamber, with first and second cylindrical rotors mounted in overlapping cylindrical chamber portions for rotation about respective parallel axes, connected by gears for synchronized rotation. The first rotor has at least one pusher extending radially outward of the first rotor's circumferential surface, and the second rotor's, circumferential surface has a corresponding at least one indenture shaped to receive the pusher during rotation of the two rotors. Side plates attached to the first rotor for rotation with the first rotor, press against spring-loaded seals and the second rotor to provide improved sealing with minimum wear.

This patent tells of a rotary steam engine that does not use pistons or a cam action as does the Rotary Cam Radial Steam Engine. It is another steam engine that could not be made of plastic or low stress materials because of the internal forces that it develops.

U.S. Pat. No. 6,128,903 of Carl Ralph Riege describes a device that is a simplified Solar Steam Engine. It consists of a sole reciprocating piston within a slotted cylinder. A piston-actuating arm extends through the slot to provide the power take off. The Actuator Arm also provides the power to a slide valve within an input/output (I/O) manifold that directs the steam correspondingly to each end of the steam engine to move the piston back and forth. The actuator arm provides the power directly to a load such as a pump piston which in turn also requires the back and forth movement to provide air pressure for air tools. Water jet propulsion power could be provided for small boats like kayaks or canoes and the like. Even compression for Home-air conditioners may be possible.

This patent describes a simplified Solar Steam Engine that consists of a sole reciprocating piston within a slotted cylinder. It does not make use of multiple cylinders or a rotating outer cam ring. On this device the manifold directs the steam correspondingly to each end of the steam engine to move the piston back and forth.

U.S. Pat. No. 6,862,973 of Jeffery Rehkemper et al. describes one embodiment a pneumatic motor that is provided including an intake chamber in fluid communication with at least one intake channel. Each intake channel is further in fluid communication with a corresponding cylinder, which receives a piston that cycles upwardly and downwardly to rotate a motor axle. A member is placed in each intake channel to seal the corresponding cylinder from each intake channel when the compressed fluid in the intake channel has a higher pressure than pressure in the corresponding cylinder. Each piston includes an actuator extending downwardly from the piston and having a profile that, during a portion of the upward cycle of the piston, causes the actuator to push the member back into each intake channel to allow compressed fluid into each of the corresponding cylinders. Each piston includes an intermediate section that has an annular groove, a seal positioned in the groove that creates a fluid tight seal against the corresponding cylinder during the upward cycle of the piston. Compressed fluid that enters the corresponding cylinder during the upward cycle will push the piston upwardly. Each section further includes exhaust grooves defined thereon such during the downward cycle of the piston the, seal is broken allowing compressed fluid in the cylinder to bypass the piston and escape through a vent above each cylinder. This causes the compressed fluid in the intake channel to push the member to re-seal the cylinder. The upward movement of the piston further generates inertia that moves the piston downward to continue the cycle

This patent describes a pneumatic motor that could be steam driven, but it does not operate by the means of multiple cylinders driven by a single central rotating valve or function by the means of a rotating outer cam ring.

U.S. Pat. No. 7,536,943 of Edward Pritchard discloses a steam engine with improved intake and exhaust flow provided by separate pairs of intake and exhaust ports located at both ends of a steam drive cylinder. A slide valve located adjacent to the drive cylinder provides for timed sealing of intake and exhaust ports during operation. Exhaust is facilitated by the provision of two paths of exhaust from the cylinder and the exhaust ports may be adjusted for a flow volume to meter exhaust steam flow to significantly reduce back pressure only at low speeds of said engine.

This patent discloses a steam engine with improved intake and exhaust flow provided by separate pairs of intake and exhaust ports using a piston that is driven from the top and bottom by the means of a valve that moves up and down. It does not make use of multiple cylinders or a rotating outer cam ring.

None of these previous efforts, however, provides the benefits attendant with the Rotary Cam Radial Steam Engine. The present design achieves its intended purposes, objects and advantages over the prior art devices through a new, useful and unobvious combination of method steps and component elements, with the use of a minimum number of functioning parts, at a reasonable cost to manufacture, and by employing readily available materials.

In this respect, before explaining at least one embodiment of the Rotary Cam Radial Steam Engine in detail it is to be understood that the design is not limited in its application to the details of construction and to the arrangement, of the components set forth in the following description or illustrated in the drawings. The Rotary Cam Radial Steam Engine is capable of other embodiments and of being practiced and carried out in various ways. In addition, it is to be understood that the phraseology and terminology employed herein are for the purpose of description and should not be regarded as limiting. As such, those skilled in the art will appreciate that the conception, upon which this disclosure is based, may readily be utilized as a basis for designing of other structures, methods and systems for carrying out the several purposes of the present design. It is important, therefore, that the claims be regarded as including such equivalent construction insofar as they do not depart from the spirit and scope of the present application.

### SUMMARY OF THE INVENTION

The principal advantage of the Rotary Cam Radial Steam Engine is to provide an economical lightweight steam engine that can be used in a variety of different applications.

Another advantage of the Rotary Cam Radial Steam Engine is that it requires low steam pressure and provides high horsepower at low revolutions per minute (RPM) with low stresses applied to its components.

Another advantage of the Rotary Cam Radial Steam Engine is through the use of material stress reduction resulting from multiple power strokes provided from each piston per single revolution of the engine results in a steam engine that can be manufactured from a variety of different inexpensive materials including plastic thus decreasing manufacturing costs.

Another advantage is having a low RPM engine that does not require reduction gears; pulley belts or chain drives lessening the amount of friction introduced into an engine and lengthen the life of the engine.

Another advantage is a powerful, low RPM engine that does not require reduction gears; pulley belts or chain drives eliminating the costs and maintenance of the normally necessary drive systems.

Another advantage of the Rotary Cam Radial Steam Engine is to provide an alternative energy mechanism, which will operate on low-pressure steam and will allow the source to be from simple solar collector or any low pressure boiler providing the steam generated by any combustible heat source including wood, paper, dung, any fossil fuel, or clothing.

Another advantage of the Rotary Cam Radial Steam Engine is that the entire central structure including stationary engine body, cylinders and valves can be simply and fully enclosed by insulation to minimize heat loss, maximize thermal efficiency and quieting the engine or source of pressure differential.

Another advantage is that the working parts of the preferred embodiment of the Rotary Cam Radial Steam Engine can be quickly and simply disassembled with no need of any tools for maintenance, rebuilding, or access to all moving parts of the engine.

Another advantage is that all parts required for normal maintenance. or replacement of all seals and piston rings can be purchased as inexpensive, common, off the shelf parts.

Another advantage of the Rotary Cam Radial Steam Engine is that the steam Consumption (fuel consumption) of the engine can be changed significantly, and inexpensively by more than or less than half with no change or modification of the stationary engine body or pistons and cylinders by a quick and simple change to a different external cam ring and central rotating valve assembly containing a higher or lower number of lobes and number of ports in the rotating valve assembly.

Another advantage of the Rotary Cam Radial Steam Engine is that the power of the engine can be changed significantly, by more than or less than half with no change or modification of the stationary engine body or pistons and cylinders by a quick and simple changing the external cam ring and central rotating valve assembly.

Another advantage of the Rotary Cam Radial Steam Engine is that the number of power strokes per piston per rotation of the engine can be changed with no change or modification of the stationary engine body or pistons and cylinders by a quick and simple changing of the external cam ring and central rotating valve assembly.

Another advantage of the Rotary Cam Radial Steam Engine is that it can be powered by a variety of different sources, steam, compressed air, other gasses, or pressurized liquid.

Yet another advantage of the Rotary Cam Radial Steam Engine is that the outer diameter of the unit rotates while the central structure remains stationary.

Another advantage is that the Rotary Cam Radial Steam Engine provides a large rotating surface that can be constructed with molded cavities or cut to accept magnets as a portion of an electrical generator armature or magneto.

Another advantage is that the Rotary Cam Radial Steam Engine provides a large rotating surface that can be molded with fins to provide air flow for cooling applications.

Another advantage is the outer rotating surface of the engine can be inexpensively molded of plastic for many usable purposes.

Another advantage is the central rotating valve assembly is central and common to the entire engine eliminating the need for separate valves for each cylinder.

And still another advantage is the steam forces maintain a constant higher pressure during compression and lower pressure on return during exhaust stroke, resulting in elimination of the need of mechanical retention to maintain contact between the piston cam roller and the outer driving cam ring.

A further advantage is the central rotating valve can also act as a steam chest to insure that a steam reservoir is available for immediate and complete fill of steam to each cylinder so that they are not hindered by orifice or pressure line sizes.

And another advantage is that the central rotating valve can have both intake and exhaust valve openings built into the same central rotating valve body. This provides efficiency, less motor internal parts, simplified mechanical design, and notably dower costs to manufacture the engine.

A further advantage is that the configuration of the engine/valve and cylinders heads located radially are close to the central rotating valve. This provides the benefit of minimum loss of temperature or steam pressure between valve and cylinder as well as precision valving for the entire radial engine from one simple valve instead of one for each cylinder.

And still another advantage is that each piston can provide more than one power stroke per rotation. A three cylinder engine of this design could have as few as three power strokes per rotation, or any multiple of three depending upon the number of lobes on the rotating outer cam ring.

Another large advantage of this design is that the radius of the “lobes” on the outer rotating cam will provide a magnified amount of leveraged power relative to the lineal stroke of the piston that would normally be provided in an engine running with a centrally located crankshaft. Thus the level of torque per lineal stroke of the piston can be adjusted.

Another advantage is the stress on each piston and cylinder to provide the rated horsepower is decreased proportionately by the number of lobes on the outer rotating cam ring. This allows engine parts to be produced from less expensive and easier formed materials

And another advantage is that the design of the engine allows the “stacking” of cases and piston arrangements to increase capability.

And another advantage is that an alternate embodiment of the Rotary Cam Radial Steam Engine, using the term uniflow exhaust design, would have progressively larger pistons and cylinders where the exhaust pressure from the smaller piston and cylinders is directed to the next larger cylinder where in turn that exhaust pressure is directed to the next larger cylinder greatly increasing the efficiency of the engine through reuse of what would normally be waste energy or exhausted steam.

A final advantage of this design is that the decreased level of stress on the engines internal components results in increased lifespan and longevity over prior engine designs.

These together with other advantages of the Rotary Cam Radial Steam Engine, along with the various features of novelty, which characterize the design, are pointed out with particularity in the claims annexed to and forming a part of this disclosure. For a better understanding of the Rotary Cam Radial Steam Engine, its operating advantages and the specific objects attained by its uses, reference should be made to the accompanying drawings and descriptive matter in which there are illustrated preferred embodiments of the Rotary Cam Radial Steam Engine. There has thus been outlined, rather broadly, the more important features of the design in order that the detailed description thereof that follows may be better understood, and in order that the present contribution to the art may be better appreciated. There are additional features of the Rotary Cam Radial Steam Engine that will be described hereinafter and which will form the subject matter of the claims appended hereto.

The novelty of this application resides in a unique preferred embodiment of the Rotary Cam Radial Steam Engine, which is powered by the means of the low pressure from gases or fluids from an external source. These pressurized fluids can be generated from a mechanical pump, from solar generated steam or from gases created through heat or cold introduced to most any fluid or gas via a boiler or other mechanism. An engine of single or multiple pistons and cylinders which are driven lineally by the introduction of pressure from an external source, through a single, centralized rotating valve designed to provide timed introduction of the pressurized gasses into each cylinder at the moment determined to be best for the engine's applied use, and then the same single central rotating valve assembly at the appropriate moment opens to allow the used pressure to exhaust it into the atmosphere, or a collection system.

The driven forces push the pistons in the Rotary Cam Radial Steam Engine in an outward direction from the center of the engine. Each piston and rod is combined as a single part or rigid assembly. The piston may have a top section fastened to it, which is of a robust harder material than the body of the piston. Each piston is designed to contain one or more piston rings to enhance compression by improving the seal in the expansion chamber between the moving piston and cylinder and head. A variety of piston rings can be used for this application but the preferred would be the conventional rubber o-ring.

The stationary engine body of the engine will be designed with a central opening to fit the centrally rotating valve. There will be cavities in the outer part of the stationary engine body, which will locate and provide seals for the cylinders. There can be one cylinder or multiple cylinders in a radial pattern to the center of the engine. The stationary engine body of the engine will further have one or more openings within each of the cylinder-locating cavities designed to allow the powering pressurized fluid or gas into the cylinder during the power portion of the stroke, and out of the cylinder during the exhaust portion of the stroke

The centrally located rotating valve will provide a common entrance point for pressurized fluids or gasses to enter into the half of the valve designed to provide timed entrance of the fluids/gasses into each cylinder. The overall diameter of the rotating valve may or may not be large enough to provide a “steam chamber” which will provide the benefit of a larger volume of steam. This steam will provide more available gas than would normally be provided for immediate use in the cylinders from a valve with no steam chest features.

The centrally rotating valve assembly has cut into it a number of openings for introduction of the pressurized fluids/gasses and is designed to accommodate the same number of cam lobes located on the outer rotating cam ring. The upper set of openings will work as the intake openings and match the number of lobes on the outer rotating cam ring, while the lower set of openings will work as the exhaust openings and will also match the number of lobes on the outer rotating cam ring. The upper openings will be offset from the lower openings depending upon the length of the stroke of the pistons. These openings can be designed and manufactured to provide a precise volume of steam for a precise percentage of time that the cylinder will be moving during its power stroke. This timing determines the amount of steam allowed into the cylinder and when the supply of steam is cut off. The manipulation of this geometry affects the efficiency of the engine as well as the amount of power available through that particular cam, as well as the amount of steam usage in running the engine. The upper and lower locations of the intake and exhaust openings may be reversed providing equal efficiency and will remain within the scope of this application. The centrally rotating valve assembly in its second chamber provides similar openings, typically open through the entire exhaust stroke of each cylinder, timed with the position of the outer rotating cam ring which allows for the used and depressurized fluids/gasses to exit the cylinders. These fluids/gasses exit through a common exit point from the valve assembly and through one or more exhaust ports in the engines case. Another feature of the engine is a port through the main body or base of the engine which would allow the first steam introduced to the engine to pass through the body or base only to be routed/ported after the body has reached a certain temperature most ideal for efficient running into the valve for distribution to the cylinders. This could be done with a simple thermostat and would allow the engine to be effectively run with no fear of water lock with the use of a less expensive source of steam which might normally provide “wetter” steam damaging the engine. Each piston will have a circular bearing and wheel located opposite of its piston head. This bearing wheel is designed to reduce friction and bear the pressure of the lineal movement of each piston during the pressurized portion of the piston's movement against the outer rotating cam ring. The Rotary Cam Radial Steam Engine entire central structure including stationary engine body, cylinders and valves can be simply and fully enclosed by insulation to minimize heat loss, maximize thermal efficiency and quieting the engine.

The outer rotating cam ring will have the same number of “lobes” in its circumference as the number of ports in each of the intake and the exhaust sections of the central rotating valve. The valve and the outer cam lobes are timed to synchronize and maximize the efficiency of the power and exhaust strokes of the centrally rotating valve with the linear motion of the pistons to provide uniform forces against the radiuses in the outer rotating cam ring. The co-ordination of the above identified forces results in a powerful circular motion of the large outer rotating cam ring. The radii and angled surfaces of the external cam ring provide surfaces on which the pistons wheels push in their power stroke. The second half of the radii provide a returning force on the pistons to return them to their top dead center in preparation of their next power stroke. The mating geometry for the central valve assembly and the outer rotating cam ring configuration incorporates a locating provision, which allows the operator of the engine to easily reverse the direction of the rotation of the engine.

The pistons in this engine have nothing restraining their movement in the outward lineal direction other than the outer rotating cam ring. There are no upward or downward forces on the valve/cam assembly. All of the forces on the assembly are outward from the force of the pistons, or inward from the compression lobe rotating against the pistons. The preferred location of the cam follower track will be on the lower surface of the outer rotating cam ring so that in order to remove the valve cam assembly, outer rotating cam ring needs only to be lifted straight up, removing the centrally located rotating valve from its enclosure in the center of the stationary engine body. Once the cam/valve assembly has been removed, each piston can be removed from its cylinder by simply pulling it out of the cylinder. Replacement of the pistons is the reverse. Simply fit the circular piston back into its open cylinder. The cam/valve assembly is re-fit in the same manor. Simply align the valve assembly with its housing in the stationary engine body and slip it down until it seats against its resting surfaces. The engine is ready to run again.

A first alternate embodiment of the Rotary Cam Radial Steam Engine is described incorporating six pistons but this does not limit the number of pistons in that a wide variety of numbers of piston's may be used and still remain within the scope of this application.

A second alternate embodiment of the Rotary Cam Radial Steam Engine will have a plurality of magnets incorporated as part of the outer rotating cam ring to be used as a generator/alternator armature.

The third alternate embodiment of the Rotary Cam Radial Steam Engine will use a machined or cast central housing which incorporates cavities to contain the piston cylinders. The third alternate embodiment will incorporate all the features of the preferred embodiment with the exception of using the machined or cast central housing and still remain within the scope of this application.

A fourth embodiment of the engine uses what is identified as a uniflow exhaust system. This embodiment will have a set of exhaust holes located radially in each cylinder of the engine around which is located an exhaust collection manifold with seals in it to insure no loss of exhaust gasses/fluids. The holes in the cylinders are located at the bottom of the piston stroke so that as the piston reaches the bottom of its stroke, the gasses/fluids are allowed to exit the cylinder through the holes into a manifold system designed to collect them. When the exhaust passes into the manifold system, it is directed to a common area to be dispersed either into the atmosphere, or into an area for collection for re-use or condensation and re-use. The uniflow embodiment of the Rotary Cam Radial Steam Engine will use a different configuration of the centrally rotating valve assembly. The entire central portion of the valve would be dedicated to the intake-power portion of the cycle. There would be only one chamber in this embodiment of centrally rotating valve assembly and one opening per lobe on the outer rotating cam ring. The prior described valve will also work in this embodiment.

A fifth embodiment of the engine would incorporate the advantages available through including a combination of different sized pistons/cylinders “re-use” of exhaust steam pressure within the Rotary Cam Radial Steam Engine being fed into a cylinder displacement larger than the previous which can provide additional power through the reuse of what would normally be lost heat/energy in the form of exhaust. This embodiment will have a set of exhaust holes located radially in each cylinder of the engine around which is located an exhaust collection manifold with seals in it to insure no loss of exhaust gasses/fluids. The holes in the cylinders are located at the bottom of the piston stroke so that as the piston reaches the bottom of its stroke, the gasses/fluids are allowed to exit the cylinder through the holes into a manifold system designed to direct them through tubes to the next larger cylinder in line greatly increasing the efficiency of the engine. When the exhaust passes out into the manifold system of the largest cylinder, it is directed to a common area to be dispersed either into the atmosphere, or into an area for collection for re-use or condensation and re-use.

With respect to the above description then, it is to be realized that the optimum dimensional relationships for the parts of this application, to include variations in size, materials, shape, form, function and manner of operation, assembly and use, are deemed readily apparent and obvious to one skilled in the art. All equivalent relationships to those illustrated in the drawings and described in the specification intend to be encompassed by the present disclosure. Therefore, the foregoing is considered as illustrative only of the principles of the Rotary Cam Radial Steam Engine. Further since numerous modifications and changes will readily occur to those skilled in the art it is not desired to limit the design to the exact construction and operation shown and described, and accordingly, all suitable modifications and equivalents may be resorted to, falling within the scope of this application.

### BRIEF DESCRIPTION OF THE DRAWINGS

The accompany ng drawings, which are incorporated in and form a part of this specification, illustrate embodiments of the Rotary. Cam Radial Steam Engine and together with the description, serve to explain the principles of this application.

FIG. 1 depicts a perspective top view: of the preferred embodiment of the Rotary Cam Radial Steam Engine using three pistons.

FIG. 2 depicts a perspective bottom view of the preferred embodiment of the Rotary Cam Radial Steam Engine using three pistons.

FIG. 3 depicts a bottom plan view of the preferred embodiment of the Rotary Cam Radial Steam Engine using three pistons.

FIG. 4 depicts a side view of the preferred embodiment of the Rotary Cam Radial Steam Engine using three pistons.

FIG. 5 depicts a top plan view of the preferred embodiment of the Rotary Cam Radial Steam Engine using three pistons.

FIG. 6 depicts an exploded perspective view of the central rotating valve with the top and bottom cap removed.

FIG. 7 depicts a perspective view of the central rotating valve with side broken away to expose the internal divider section.

FIG. 8 depicts an exploded perspective view of the preferred embodiment of the Rotary Cam Radial Steam Engine using three pistons and illustrating the construction of one piston assembly.

FIG. 9 depicts an exploded perspective view of the preferred embodiment of the Rotary Cam Radial Steam Engine illustrating in greater detail the construction of one piston assembly.

FIG. 10 depicts a bottom view of the second alternate embodiment of the Rotary Cam Radial Steam Engine exposing a plurality of permanent magnets to be used as a generator armature.

FIG. 11 depicts a top perspective view of a third alternate embodiment of the Rotary Cam Radial Steam Engine using a cast central housing.

FIG. 12 depicts a bottom perspective view of a third alternate embodiment of the Rotary Cam Radial Steam Engine using a cast central housing.

FIG. 13 depicts a top plan view of a third alternate embodiment of the Rotary Cam Radial Steam Engine using a cast central housing with a portion of the lower cylinder broken away exposing the location of the piston assembly.

FIG. 14 depicts a bottom view of a third alternate embodiment of the Rotary Cam Radial Steam Engine using a cast central housing.

FIG. 15 depicts an exploded perspective view of both sections of the cast central housing, namely, the upper cast central housing and the lower cast central housing.

FIG. 16 depicts an exploded view of both segments of the third alternate embodiment of the Rotary Cam Radial Steam Engine using a cast central housing.

FIG. 17 depicts an exploded perspective view of a fourth alternate embodiment of the Rotary Cam Radial Uniflow Steam Engine using the basic configuration of the preferred embodiment of the Rotary Cam Radial Steam Engine.

FIG. 18 depicts a perspective view of the optional uniflow central rotating valve.

FIG. 19 depicts a bottom view of the fifth alternate embodiment of the Rotary Cam Radial Steam Engine using a combination of different sized piston cylinders.

FIG. 20 depicts a perspective view of the stationary engine body of the fifth alternate embodiment of the Rotary Cam Radial Steam Engine.

FIG. 21 a schematic top view of the fifth alternate embodiment of the Rotary Cam Radial Steam Engine illustrating the direction of exhaust flow.

For a fuller understanding of the nature and advantages of the Rotary Cam Radial Steam Engine, reference should be made to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

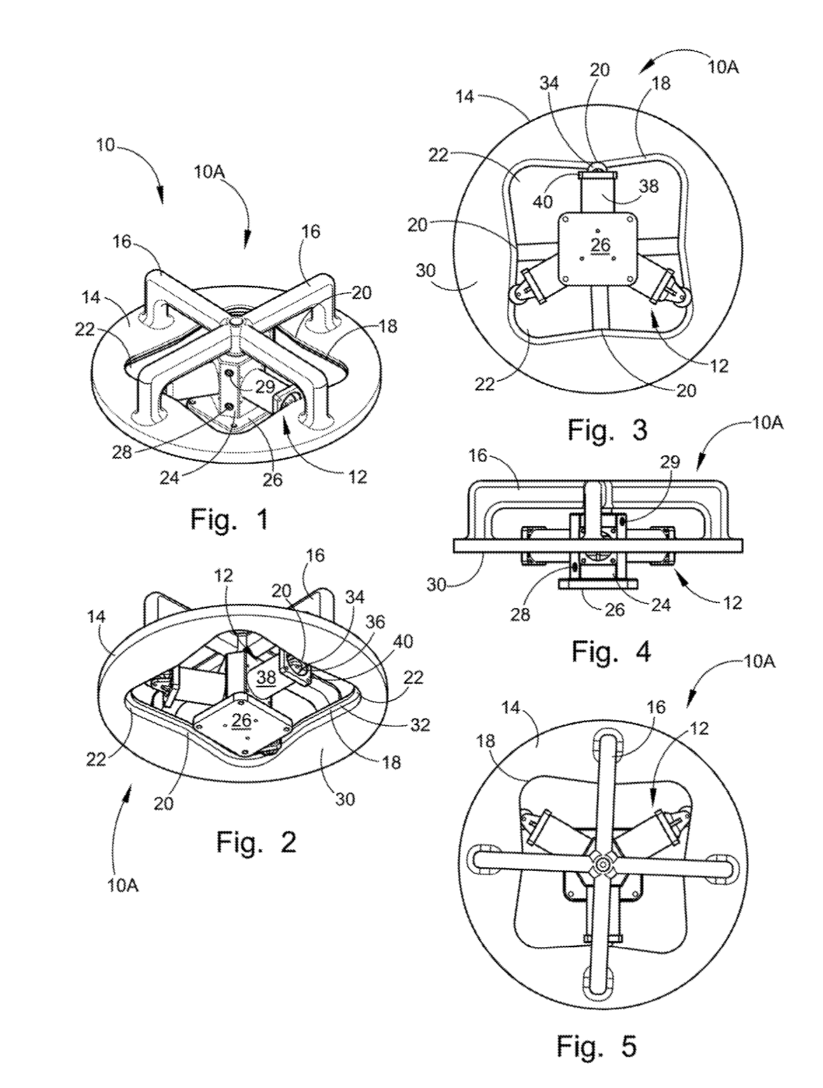

Referring now to the drawings, wherein similar parts of the Rotary Cam Radial Steam engine 10 are identified by like reference numerals, there is seen in FIG. 1 a perspective top view of the preferred embodiment of the Rotary Cam Radial Steam Engine 10A using three piston assemblies 12. The Rotary. Cam Radial Steam engine 10 has been depicted in the horizontal position but it must be understood that the Rotary Cam Radial Steam engine 10 can operate in a wide variety of positions including vertical and still remain within the scope of this application. The outer rotating earn ring 14 with the supporting frame 16 incorporating a unique cam follower track 18 is configured with four compression lobes 20 and four exhaust cavities 22. It must be fully understood at this time that the Rotary Cam Radial Steam engine 10 can be configured with one, or more piston assemblies 12, two or more compression lobes 20 and two or more exhaust cavities 22 on an external rotating cam ring 14 while remaining within the scope of this application. The stationary engine body 24 is fixed to the engine mounting base plate 26 to be attached to a supporting structure. The stationary engine body 24 and the three-piston assemblies 12 remain in a fixed position while the outer rotating cam ring 14 rotates around a central axis. One or more engine body exhaust ports 28 is shown in the lower surface of the stationary engine body 24 along with ones or more engine intake

FIG. 2 depicts a perspective bottom view of the preferred embodiment of the Rotary Cam Radial Steam Engine 10A using three piston assemblies 12, four compression lobes 20 and four exhaust cavities 22. This illustration shows the outer rotating cam ring 14 lower surface 30 and the cam roller shelf 32 located within the cam follower track 18. The piston cam roller 34 is visible at the upper end of the piston 36 resting within the piston cylinder 38 and held in place by the means of a cylinder retainer 40.

FIG. 3 depicts a bottom plan view of the preferred embodiment of the Rotary Cam Radial Steam Engine 10A using three piston assemblies 12. FIG. 4 and FIG. 5 depicts a side view and top plan view of the preferred embodiment of the Rotary Cam Radial Steam Engine 10A using three piston assemblies 12.

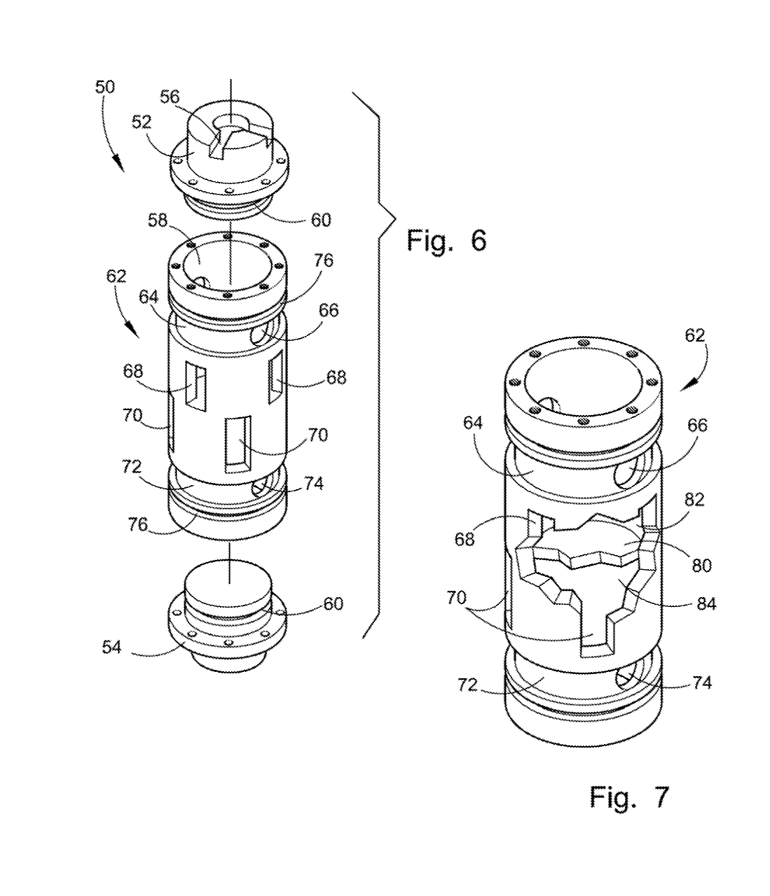

FIG. 6 depicts an exploded perspective view of the central rotating valve assembly 50 with the upper cap 52 and the lower cap 54. The upper cap 52 has a forward and a reverse rotational direction slot 56 on the upper surface. The upper cap 52 engages within the steam chest area 58 of the central rotating valve 50 and seals by the means of an o-ring in the o-ring groove 60. The exterior surface of the central rotating valve 62 consists of a valve intake groove 64 with one or more main intake ports 66 into the steam chest area 58. One or more intake openings 68 lead into piston cylinder 38 and one or more exhaust openings 70 release the pressure into the lower steam chest cavity 84 depicted in FIG. 7, where it is ducted out through one or more main exhaust ports 74, and into the valve exhaust groove 72. O-ring grooves 76 at the top and bottom of the central rotating valve 50 seal the device within the rotating valve cavity 78 in the stationary engine body 24. FIG. 7 depicts a perspective view of the central rotating valve 62 with the side broken away to expose the internal divider section 80 and the upper steam chest cavity 82 and lower steam chest cavity 84.

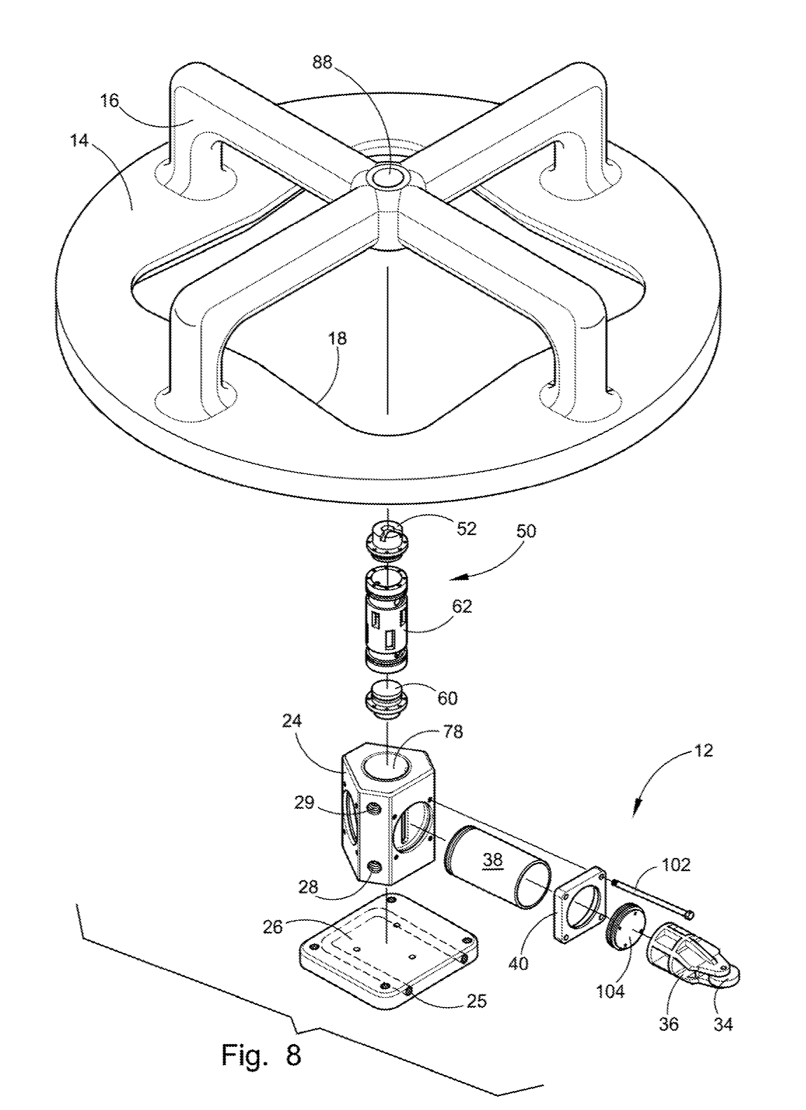

FIG. 8 depicts an exploded perspective view of the preferred embodiment of the Rotary Cam Radial Steam Engine 10A where the outer rotating cam ring 14 is shown above the central rotating valve assembly 50, the stationary engine body 24 and the piston assembly 12. The piston assembly has threads. The central rotating valve assembly 50 will be fixably attached to the supporting frame 16 in the Rotating valve mounting orifice 88.

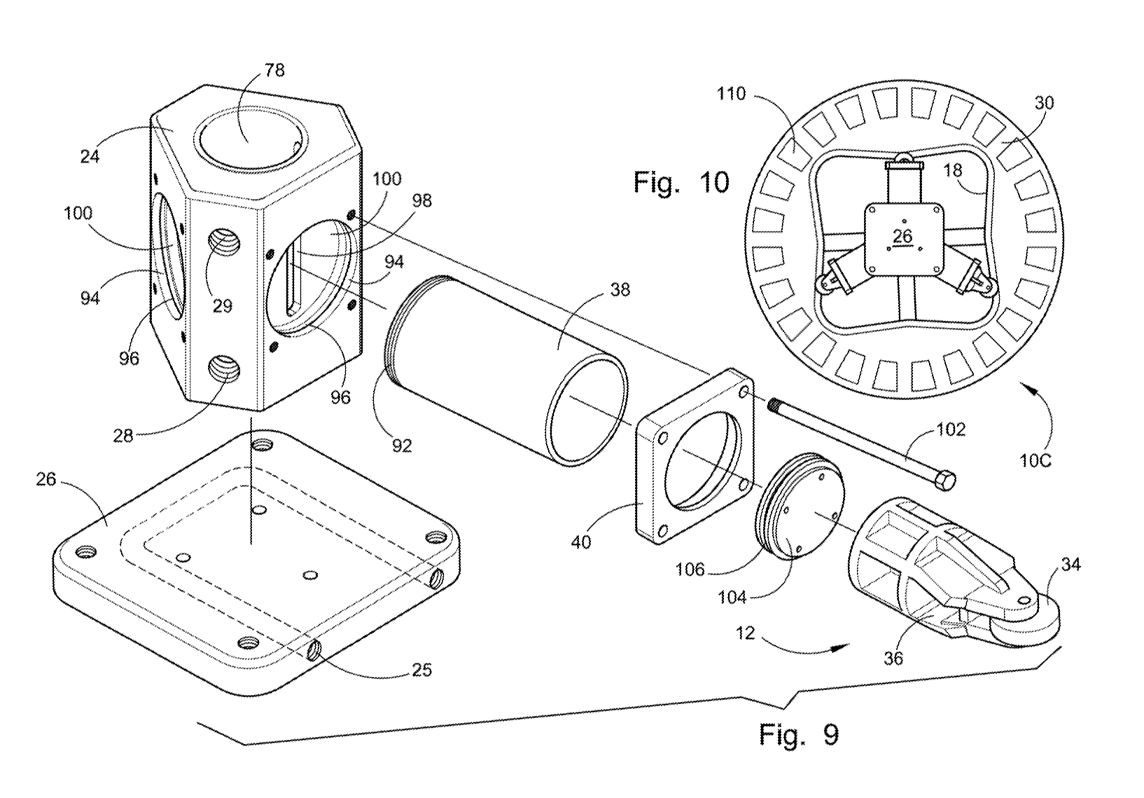

FIG. 9 depicts an enlarged exploded perspective view of stationary engine body 24 and the piston assembly 12 of the preferred embodiment of the Rotary Cam Radial Steam Engine 10A. Cylinder locating cavity 94 with an o-ring groove 96 sealing the piston cylinder 38 are shown on the sides of the stationary engine body 24. The stationary engine body 24 has an optional pre-heat chamber 25 that is a port through the Engine mounting base plate 26 that will allow the first steam introduced to the engine to pass through the stationary engine body 24 only to be routed/ported after the body has reached a certain temperature most ideal for efficient running into the central rotating valve assembly 50 for distribution to the cylinders 38. An elongated slot 98 is located on the back wall 100 of the locating cavity 94 extending into the upper steam chest cavity 82 and lower steam chest cavity 84. One or more engine bore exhaust ports 28 enter into the rotating valve cavity 78 along with one or more engine intake ports 29 that are in alignment with the valve intake groove 64 in the central rotating valve 62. The piston cylinder 38 with optional threads 92 is shown adjacent to the cylinder retainer 40 that will be secured to the Stationary engine body 24 by the means of four cylinder mounting bolts 102. The cylinder 38 can also be retained to the main body 24 by means of threaded connection on each directly connecting the two pieces. A piston cap 104 with one or more o-ring groove 106 secured to the piston 36 moves independently within the piston cylinder 38.

FIG. 10 depicts a bottom view of a second alternate embodiment of the Rotary Cam Radial Steam Engine 10C exposing a plurality of permanent magnets 110 imbedded into the rotating cam ring lower surface 30 to be used as a generator armature.

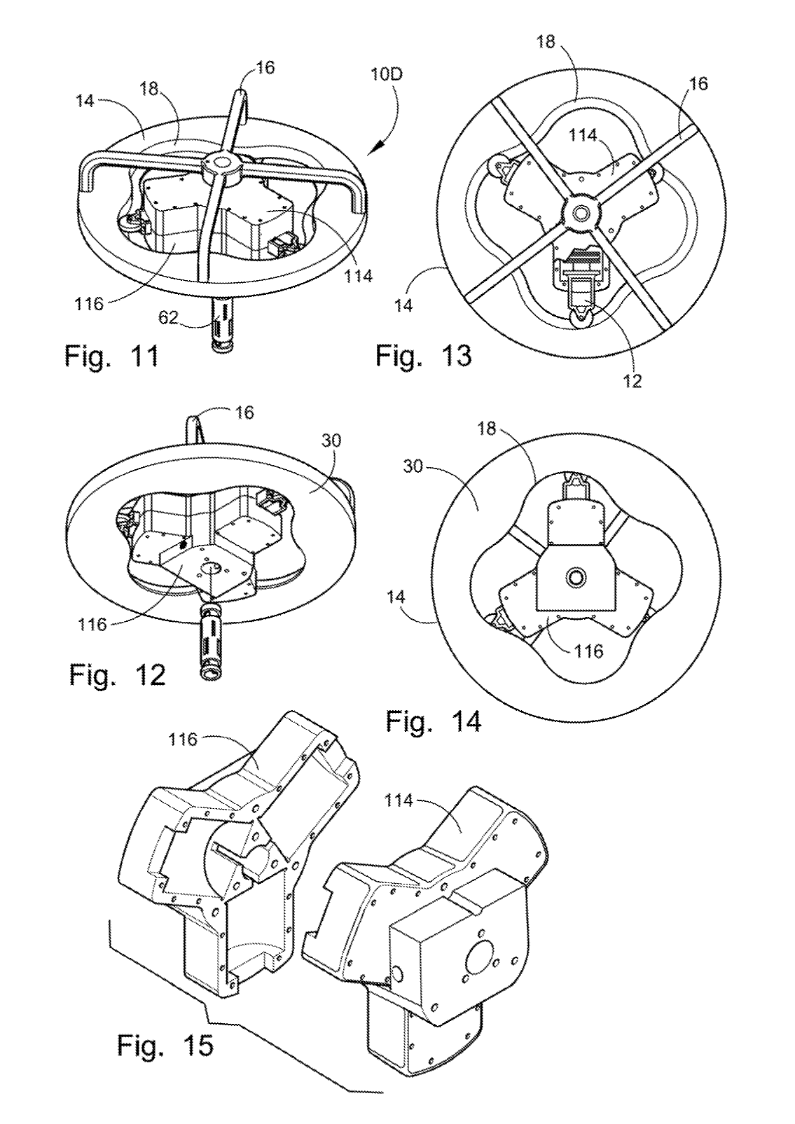

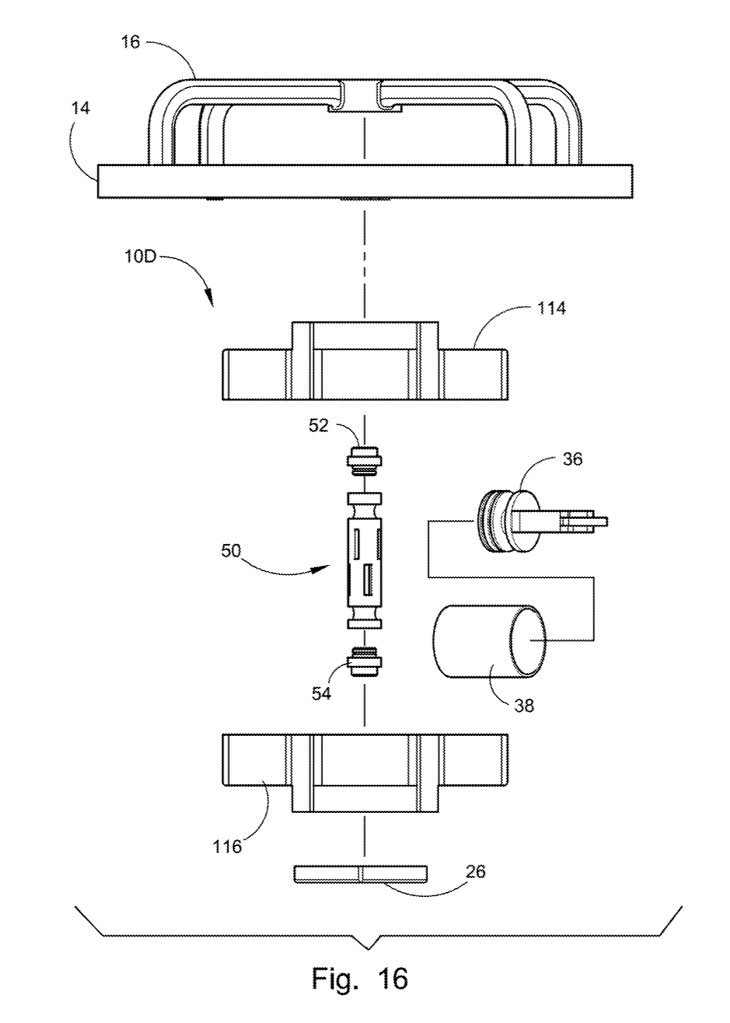

FIG. 11 depicts a top perspective view of a third alternate embodiment of the Rotary Cam Radial Steam Engine 10D using cast central housing halves 114 and 116 retaining the piston cylinder 38. The outer rotating cam ring 14 and the central rotating valve 62 can be typical throughout all of the embodiments of the Rotary Cam Radial Steam engine 10. FIG. 12 depicts a bottom perspective view of a third alternate embodiment of the Rotary Cam Radial Steam Engine 10D. FIG. 13 depicts a top plan view of a second alternate embodiment of the Rotary Cam Radial Steam Engine 10D with a portion of the lower cylinder broken away exposing the location of the piston assembly 12. FIG. 14 depicts a bottom view of the third alternate embodiment of the Rotary Cam Radial Steam Engine 10D. FIG. 15 depicts an exploded perspective view of both typical sections of cast central housing 116. FIG. 16 depicts an exploded side view of a third alternate embodiment of the Rotary Cam Radial Steam Engine 10D illustrating both the top half of the cast central: housing 114 and the bottom half of the cast central housing 116 also illustrating the piston 36 and the piston cylinder 38.

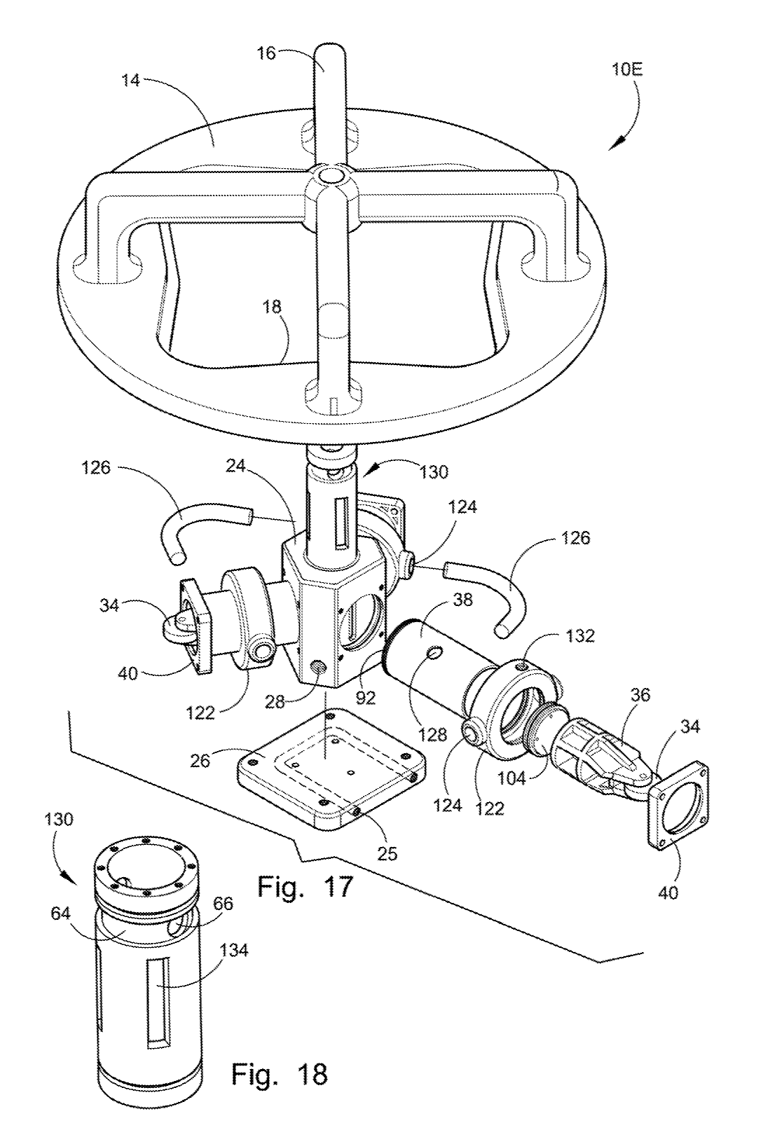

FIG. 17 depicts an exploded perspective view of a fourth alternate embodiment of the Rotary Cam Radial Uniflow Steam Engine 10E. This engine uses the basic configuration of the preferred embodiment of the Rotary Cam Radial Steam Engine 10 except for exhaust manifolds 122 with orifices 124 leading to interconnecting exhaust elbows 126 covering one or more uniflow exhaust ports 128 in each of the piston cylinders 38. The exhaust is then emitted through an exhaust port 132 in the exhaust manifold 122.

FIG. 18 depicts a perspective view of the optional uniflow central rotating valve 130 having only the intake port 66 along with the valve intake groove 64, with the exhaust totally removed by the means of the uniflow exhaust ports 128 in the piston cylinders 38. This uniflow central rotating valve assembly 130 would not have the exhaust port 70 that is used in the previously described central rotating valve 62. Another difference between this central rotating assembly 130 and the previously described central rotating valve 64 is the presence of the elongated slot intake opening 134.

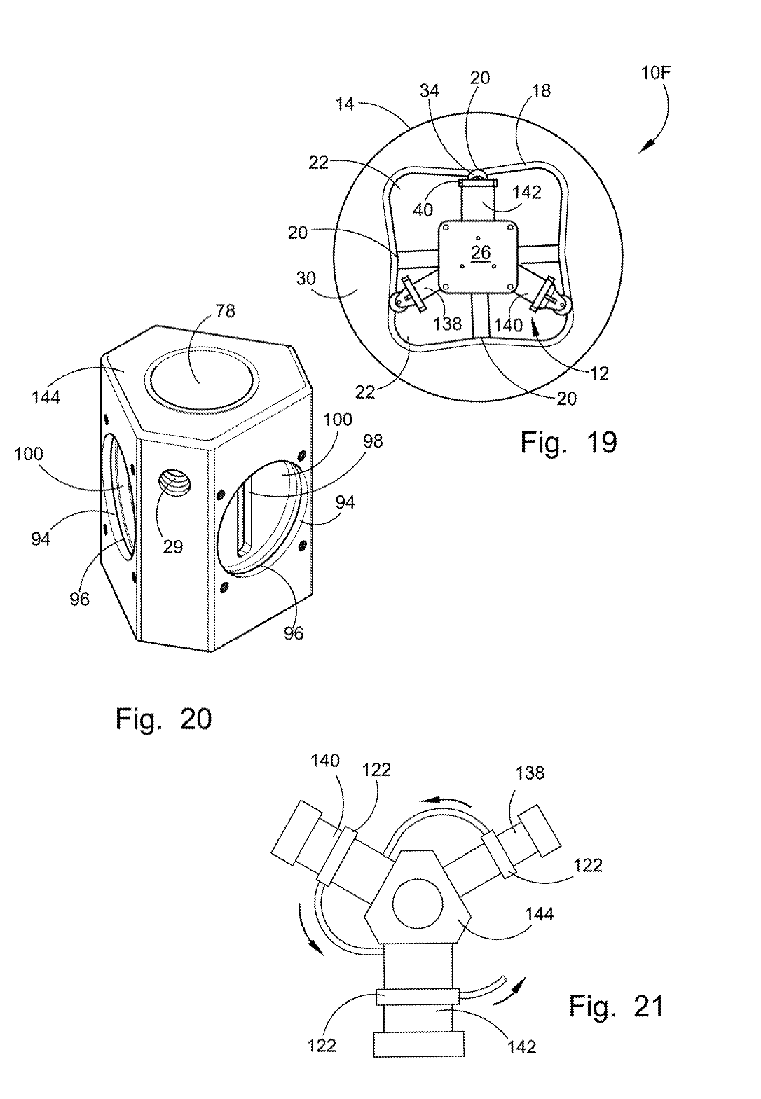

FIG. 19 depicts a bottom view of the fifth alternate embodiment of the Rotary Cam Radial Steam Engine 10F using a combination of different sized piston cylinders assemblies 138, 140 and 142.

FIG. 20 depicts a perspective view of the stationary engine body 144 of the fifth alternate embodiment of the Rotary Cam Radial Steam Engine 10F where only one of the cylinder locating orifice back walls 100 has an elongated slot 98 in it and the others are solid. This is because the exhaust is directed from the other exhaust ports.

FIG. 21 a schematic top view of the fifth alternate embodiment of the Rotary Cam Radial Steam Engine 10F illustrating the direction of exhaust flow. This view/illustration shows the exhaust being collected at the prior and smaller cylinder 138 in one of the exhaust manifolds 122 and directed towards the case to cylinder joint area where the piston will be then driven outward lineally until the top of the piston has reached the uniflow exhaust area for the exhaust gasses to be exhausted and directed to the next larger piston 140, or out of the engine in the case of the last piston 142 to make use of the exhaust steam

The Rotary Cam Radial Steam Engine 10 shown in the drawings and described in detail herein disclosed arrangements of elements of particular construction and configuration for illustrating preferred embodiments of structure and method of operation of the present application. It is to be understood, however, that elements of different construction and configuration and other arrangements thereof, other than those illustrated and described may be employed for providing a Rotary Cam Radial Steam Engine 10 in accordance with the spirit of this disclosure, and such changes, alternations and modifications as would occur to those skilled in the art are considered to be within the scope of this design as broadly defined in the appended claims

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

1. A rotary cam radial steam engine comprising:
(a) outer rotating cam ring including a supporting frame incorporating a cam follower track configured with four or more compression lobes and four or more exhaust cavities thereon;
(b) a stationary engine body affixed to an engine mounting base plate wherein said engine body includes one or more engine body exhaust ports and one or more engine body intake ports, and said engine body has three or more cylinder locating cavities which include cylinder locating cavity back walls each including an elongated slot;
(c) three or more piston assemblies affixed to said stationary engine; and
(d) a central rotating valve assembly having three or more orifices therein, and wherein said central rotating valve is centrally located within said engine stationary body and free to rotate therein;
whereby when steam is injected into said engine body intake ports said central rotating valve is actuated, rotates and delivers steam through said orifices and into said piston assemblies forcing said piston assemblies to move outward engaging said outer rotating cam ring and causing said outer rotating cam ring to rotate.

2. The rotary cam radial steam engine, according to claim 1, wherein said outer rotating cam ring further includes a supporting frame and a follower track wherein said follower track further defines said compression lobes and said exhaust cavities thereon.

3. The rotary cam radial steam engine, according to claim 1, wherein said piston assemblies further include a piston having an inner portion and an outer portion, a piston cylinder, a cylinder retainer and a piston cap removably attached to the inner portion of said piston and a piston cam roller rotatably attached to the outer portion of said piston.

4. The rotary cam radial steam engine, according to claim 1, wherein said central rotating valve assembly includes an upper cap, a lower cap, a steam chest area, one or more valve intake grooves, and one or more intake openings and exhaust openings.

5. The rotary cam radial steam engine, according to claim 4, wherein said steam chest area further includes a steam chest divider section, dividing said steam chest area into an upper steam chest cavity and a lower steam chest cavity.

6. The rotary cam radial steam engine, according to claim 3, wherein said piston assemblies include piston cylinders that are threaded on one end and are attached to said stationary engine body by being threaded onto said cylinder locating cavities which include reverse threads.

7. The rotary cam radial steam engine, according to claim 1, wherein said engine mounting base plate further includes an optional pre-heat chamber therein.

8. The rotary cam radial steam engine, according to claim 1, wherein said stationary engine body comprises an upper cast central housing unit and a lower cast central housing unit which encloses said three or more piston assemblies and accommodates said central rotating valve assembly.

9. The rotary cam radial steam engine, according to claim 1, wherein said three or more piston assemblies are comprised of varying sized piston assemblies and further wherein said varying sized piston assemblies include interconnecting elbows, exhaust ports and manifold orifices, enabling the exhaust steam from one piston assembly to flow on through to the next size piston assembly.

10. The rotary cam radial steam engine, according to claim 9, wherein said central rotating valve assembly includes only one valve intake groove.

11. A method for making a rotary cam radial steam engine, comprising the steps of:
(a) providing an outer rotating cam ring including a supporting frame incorporating a cam follower track configured with four or more compression lobes and four or more exhaust cavities thereon;
(b) providing a stationary engine body affixed to an engine mounting base plate wherein said engine body includes one or more engine body exhaust ports and one or more engine body intake ports, and said engine body has three or more cylinder locating cavities which include cylinder locating cavity back walls each including an elongated slot;
(c) providing three or more piston assemblies affixed to said stationary engine;
(d) providing a central rotating valve assembly having three or more orifices therein, and wherein said central rotating valve is centrally located within said engine stationary body and free to rotate therein; and
(e) injecting steam into said engine body intake ports;
whereby when steam is injected into said engine body intake ports said central rotating valve is actuated, rotates and delivers steam through said orifices and into said piston assemblies forcing said piston assemblies to move outward engaging said outer rotating cam ring and causing said outer rotating cam ring to rotate.

12. The method for making a rotary cam radial steam engine, according to claim 11, wherein said step of providing an outer rotating cam ring includes the step of providing an outer rotating cam ring which includes a supporting frame and a follower track wherein said follower track further defines said compression lobes and said exhaust cavities thereon.

13. The method for making a rotary cam radial steam engine, according to claim 11, wherein said step of providing three or more piston assemblies includes the step of providing three or more piston assemblies wherein said piston assemblies further include a piston having an inner portion and an outer portion, a piston cylinder, a cylinder retainer and a piston cap removably attached to the inner portion of said piston and a piston cam roller rotatably attached to the outer portion of said piston.

14. The method for making a rotary cam radial steam engine, according to claim 11, wherein said step of providing a central rotating valve assembly further includes the step of providing a central rotating valve assembly wherein said central rotating valve assembly includes an upper cap, a lower cap, a steam chest area, one or more vale intake grooves, and one or more intake openings and exhaust openings.

15. The method for making a rotary cam radial steam engine, according to claim 14, wherein said step of providing a central rotating valve having a steam chest area includes the step of providing a central rotating valve having a steam chest area wherein said steam chest area further includes a steam chest divider section, dividing said steam chest area into an upper steam chest cavity and a lower steam chest cavity.

16. The method for making a rotary cam radial steam engine, according to claim 13, wherein said step of providing three or more piston assemblies further includes the step of providing three or more piston assemblies wherein said piston assemblies include piston cylinders that are threaded on one end and are attached to said stationary engine body by being threaded onto said cylinder locating cavities which include reverse threads.

17. The method for making a rotary cam radial steam engine according to claim 11, wherein said step of providing a stationary engine body affixed to an engine mounting base plate includes the step of providing an engine mounting base plate wherein said engine mounting base plate further includes an optional pre-heat chamber therein.

18. The method for making a rotary cam radial steam engine, according to claim 11, wherein said step of providing a stationary engine body further includes the step of providing a stationary engine body wherein said stationary engine body comprises an upper cast central housing unit and a lower cast central housing unit which encloses said three or more piston assemblies and accommodates said central rotating valve assembly.

19. The method for making a rotary cam radial steam engine, according to claim 11, wherein said step of providing three or more piston assemblies further includes the step of providing three or more piston assemblies wherein said three or more piston assemblies are comprised of varying sized piston assemblies and further wherein said varying sized piston assemblies include interconnecting elbows, exhaust ports and manifold orifices, enabling the exhaust steam from one piston assembly to flow on through to the next size piston assembly.

20. The method for making a rotary cam radial steam engine, according to claim 19, wherein said step of providing a central rotating valve assembly further includes the step of providing a central rotating valve assembly wherein said central rotating valve assembly includes only one valve intake groove.
